(19) United States
(12) Patent Application Publication
(10) Pub. No.: US 2022/0320559 A1
(43) Pub. Date: Oct. 6, 2022

(54) PHOTOSYNTHETIC POWER CELL DEVICES AND MANUFACTURING METHODS

(71) Applicants: MUTHUKUMARAN PACKIRISAMY, PIERREFONDS (CA); KIRANKUMAR KURUVINASHETTI, MONTREAL (CA)

(72) Inventors: MUTHUKUMARAN PACKIRISAMY, PIERREFONDS (CA); KIRANKUMAR KURUVINASHETTI, MONTREAL (CA)

(21) Appl. No.: 17/223,224

(22) Filed: Apr. 6, 2021

(51) Int. Cl. H01M 8/16

(52) U.S. Cl. CPC H01M 8/16

(57) ABSTRACT

Unlike the microbial fuel cells (MFC) that always needs the carbon stock for its operation photosynthetic cells (μPSC) do not need any organic fuel. Moreover, the μPSC generate electricity in both light and dark conditions. To date most of the μPSC were being fabricated using microfabrication technology which is expensive and tedious and requires clean room fabrication facilities. The current proposed fabrication method generates (harvests) energy relatively higher than the other fabrication processes. Moreover, this fabrication method is beneficial over previous methods in terms of simple and cost effective and inexpensiveness. This invention proposes the fabrication of the micro photosynthetic power cell with gold sputtered micro metal arrayed grid-foils followed by bonding to the proton exchange membrane with no space between the electrodes and the proton exchange membrane. In addition to the several advantageous all the materials utilized for the fabrications are completely biodegradable.

### FIELD OF THE INVENTION

This patent application relates to alternative renewable energy sources and more particularly to microbial fuel cells.

### BACKGROUND OF THE INVENTION

Energy demand globally is increasing rapidly. With the present rates of increase of energy demand, it is difficult to supply the power from the current energy sources. Oil production will reach its peak in 2030 and decrease rapidly thereafter. Moreover, due to the excessive use of non-renewable energy resources such as coal, oil, and natural gas, over the past hundred years the emission of carbon dioxide has increased at least 300 times more compared to that from renewable energy sources such as solar, wind, and biomass.

Whilst the utilization factor of solar energy to biomass conversion is only 0.25% it is estimated that the earth's photosynthetic organisms convert more than ten times as much energy per year as current human energy consumption. Therefore, to explore the advantages of both the biological and synthetic approaches, a technology is required which makes use of the high energy conversion efficiency of the synthetic systems, whilst exploiting the merits of a low cost biological approach.

To this effect, biological photovoltaics (BPV) exploiting micro-photosynthetic cells (μPSC) can generate electricity to power low and ultra-low power applications by exploiting photosynthesis of living photosynthetic organisms. A key benefit of the μPSC is that they consist of living photosynthetic organisms that allow for continuous repair of photodamage to key proteins. In addition, unlike semiconductor photovoltaics which function only in light μPSCs function both in light conditions by oxygenic photosynthesis and in dark conditions by oxidation of carbohydrates which were synthesized by carbon dioxide.

At present, the power density of μPSCs is low, through several factors that still need to be explored. Therefore, additional work is necessary to understand the factors which are limiting the performance of the μPSC in terms of cellular level biophysics, engineering design, fabrication and arraying configurations to harness more energy from photosynthesis.

Within the prior art Chiao et al. in “Micromachined Microbial and Photosynthetic Fuel Cells” (J. Micromechanics Microengineering, Vol. 16, No. 12, pp. 2547-2553, 2006) employed bulk silicon micromachining technology for fabricating the compartments of the μPSC. The blue-green algae (Phylum Cyanophyta) was utilized to generate power. In other work Ramanan et al. “Advanced Fabrication , Modeling , and Testing of a Microphotosynthetic Electrochemical Cell for Energy Harvesting Applications” (IEEE Trans. Power Electron., vol. 30, no. 3, pp. 1275-1285, 2015) and Shahparnia et al. “Micro Photosynthetic Power Cell for Power Generation from Photosynthesis of Algae” *Technology, Vol. 03, pp. 119-126, 2015) employed microfabrication technology to fabricate the μPSC. These and other similar prior art approaches involve microfabrication techniques which are expensive.

Accordingly, it would be beneficial to establish μPSC manufacturing techniques which do not require clean room facilities to fabricate these μPSCs as well as eliminating semiconductor processing methodologies etc. Accordingly, the inventors have established a simple, low cost, easily producible, reliable μPSC design.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to alternative renewable energy sources and more particularly to microbial fuel cells.

In accordance with an embodiment of the invention there is provided a method of fabricating a power cell comprising:

providing an upper electrode formed of a first material with arrayed openings of first dimensions therein;
providing a lower electrode formed from a second material with arrayed openings of second dimensions therein;
providing a proton exchange membrane (PEM) between the upper electrode and the lower electrode;
providing a first chamber filled with an anolyte comprising a photosynthetic organic material that performs photosynthesis disposed such that the upper electrode is in contact with the anolyte solution;
providing a second chamber filled with a catholyte disposed such that the lower electrode is in contact with the catholyte solution; and
an optically transparent window allowing light to enter the power cell and enable a photosynthetic reaction in the photosynthetic organic material.

In accordance with an embodiment of the invention there is provided a power supply comprising:

a plurality of power cells, each power cell comprising:
an upper electrode formed of a first material with arrayed openings of first dimensions therein in contact with an anolyte solution comprising a photosynthetic organic material that performs photosynthesis;
providing a lower electrode formed from a second material with arrayed openings of second dimensions therein in contact with a catholyte solution;
providing a proton exchange membrane (PEM) between the upper electrode and the lower electrode; and
an optically transparent window allowing light to enter the power cell and enable a photosynthetic reaction in the photosynthetic organic material.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts the operating principle of a micro-photosynthetic power cell (μPSC);

FIGS. 2A to 2I depict the components and assembly of prototype μPSCs according to embodiments of the invention;

FIGS. 3A and 3B depict schematics and results of datalogging current and voltage data from μPSCs according to embodiments of the invention;

FIGS. 4A to 4C depict I-V and I-P characteristics of μPSCs according to embodiments of the invention under different illumination conditions;

FIG. 5 depicts exemplary configurations for combining μPSCs according to embodiments of the invention;

FIGS. 6A and 6B presents tables of configurations for combining μPSCs according to embodiments of the invention;

FIGS. 6C and 6D depict optical micrographs of two configurations for combining μPSCs according to embodiments of the invention;

FIG. 7 depicts an experimental configuration for measuring current and voltage characteristics of arrays of μPSCs according to embodiments of the invention;

FIGS. 8A and 8B depict I-V characteristics for two different combination configurations of μPSCs according to embodiments of the invention;

FIGS. 9A and 9B depict power-current characteristics for two different combination configurations of μPSCs according to embodiments of the invention;

FIG. 10 depicts schematics of LED connection circuits to arrays of μPSCs according to embodiments of the invention together with LED illuminations;

FIG. 11 depicts an assembly of array configurations of μPSCs according to embodiments of the invention for a 1 m² device; and

FIG. 12 depicts examples of arrayed grid-foils according to embodiments of the invention.

### DETAILED DESCRIPTION

The present invention is directed to alternative renewable energy sources and more particularly to microbial fuel cells.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

Like solar cells, a micro-photosynthetic cell (μPSC) operates when illuminated. However, operation does not stop when the device is in darkness. In some respects, a period of no illumination may help restore the device. Thus, the device can be operated continuously under light and dark conditions. In an engineering sense, photosynthesis is the mechanism of converting light energy to chemical energy in plants and other biological systems. It is a complex process taking place in higher level plants, algae, phytoplankton and bacteria. In order to perform photosynthesis, these organisms require light, water and carbon dioxide. Photosynthesis splits water molecules, liberates oxygen and combines hydrogen with the carbon dioxide for carbon fixation, a process leading to production of sugars and photosynthetic food. Accumulation of oxygen in the atmosphere enables living creatures to consume the photosynthesized food and derive energy from the food by “respiration” a process in which organic compounds are oxidized back to carbon dioxide and water.

Both photosynthesis and respiration involve electron transport chains which are the basic premise of the operation of the μPSC. The electrons are released in one step and taken up in another. The idea is to interfere with the electron-transfer chain in such a way that the electrons get directed through an external load, resulting in electric current.

Photosynthesis occurs in two stages: light dependent or photosynthetic reactions and light independent or dark reactions, known collectively as the Calvin-Benson cycle. In the former, the light energy is captured and used to make high energy (excited) molecules whereas in the dark reactions the high energy molecules are used to capture carbon dioxide and make carbohydrates. By using an appropriate frequency and wavelength of light, molecules can be transformed from a defined initial state to a defined excited state.

In the light reactions, one molecule of the pigment chlorophyll absorbs one photon and loses one electron. Passing through various stages, the electron transport chain leads to the reduction of NADP (nicotinamide adenine dinucleotide phosphate) to NADPH+ (nicotinamide adenine dinucleotide phosphate-oxidase). NADP is a coenzyme used in anabolic reactions, such as lipid and nucleic acid synthesis. NADPH+ is a membrane-bound enzyme complex which generates super-oxide by transferring electrons from NADP inside the cell across the membrane and coupling the electrons to molecular oxygen to produce the super-oxide. NADP is reduced in the last step of the light reactions producing NADPH which is then used as a power source for the biosynthetic reactions in the Calvin-Benson cycle of photosynthesis. Concomitantly, the electron transport induces a pH gradient, across a thylakoid membrane of the cell, which is needed for the formation of adenosine triphosphate (ATP), a source of energy used in the biochemical reactions. The chlorophyll regains the lost electron by taking one from a water molecule through a process called photolysis, which releases oxygen.

In the dark reactions, enzymes capture CO₂ and release 3-carbon sugars, which are later combined to form sucrose and starch as given by Equations (1) and (2) where:
ATP (adenosine triphosphate) from photophosphorylation in which one molecule of ATP contains three phosphate groups, and it is produced by ATP synthase from inorganic phosphate and adenosine diphosphate (ADP) or adenosine monophosphate (AMP)); and
NADP (nicotinamide adenine dinucleotide phosphate)—from photo reduction in Equation (2). Respiration photosynthesis and respiration are reversible bio-chemical reactions, meaning that the products of one process are the reactants for the opposite process. Hence cellular respiration is the opposite of photosynthesis; glucose or other carbohydrates oxidise to produce carbon dioxide, water and chemical energy.

6CO₇+12H₂O [symbol] C₆H₁₂O₆+6O₂+6H₂O (1)

2H₂O+2NADP+2ADP+light→2NAPDH+2H⁺+2ATP+O₂ (2)

Equations (3) and (4) gives the cellular respiration reaction corresponding to the photosynthesis reaction mentioned above.

C₆H₁₂O₆+6O₂→6CO₂+12H₂O (3)

Glucose+Oxygen→Carbon dioxide+Water

Accordingly, both photosynthesis and respiration are involved with electron transport chains. As a result, the μPSC can be operated in either light or dark conditions. However, for best efficiencies and maximum lifetime of the device, cycles of light and dark conditions offer benefits. As such μPSCs are well suited to deployment in the environment with alternating light (day) and dark (night).

Electron transfer or moving of electrons from one site to another is among the most common chemical processes. As mentioned above, in the light reactions, one molecule of the pigment chlorophyll absorbs one photon and loses one electron. The released electron goes through several stages involving various electron donors and acceptors.

Accordingly, one of the issues within photosynthetic energy cells is establishing the photosynthesis reaction in close proximity to the ionic and exchange transfer locations. The efficiency of energy harvesting is dependent on the proximity between the electron conducting electrodes and proton exchanging membrane and the photosynthetic organisms. Within the prior art, see for example, U.S. Pat. No. 10,615,440 “Scalable Micro Power Cells with No-Gap Arrangement between Electron and Proton Transfer Elements” an arrangement with no gap (hereinafter “no-gap arrangement”) between the electron conducting metal electrodes and the proton exchanging membranes was established. This no-gap arrangement can increase the surface to volume ratio of the electrodes, leading to an increase of energy harvesting efficiency. The contents of U.S. Pat. No. 10,614,440 being incorporated herein by reference.

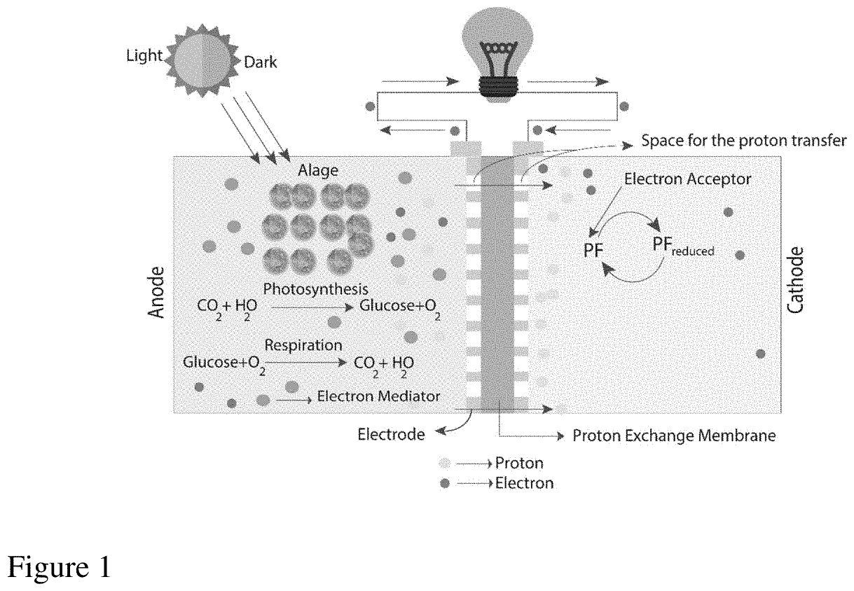

A micro-photosynthetic cell (μPSC) as depicted in FIG. 1 consists of an anode, a cathode chamber, and a membrane electrode assembly (MEA) sandwiched between them. The anode chamber consists of photosynthetic biological material, e.g., microorganisms such as cyanobacteria/blue-green algae for example, which release electrons under both photosynthesis and respiration processes. An electron mediator in the anode chamber diffuses into the photosynthetic biological material (e.g., algae), to siphon the electrons and protons from electron transport chains of photosynthesis and transfers them to the anode surface through the reduction and oxidation processes. The released electrons travel through an external resistance generating electricity from the μPSC. The membrane electrode assembly separates the anode and cathode chambers. Further the proton exchange membrane in MEA blocks the electrons and only allows protons to pass through it. At the cathode surface, the catholyte accepts the electrons and forms reduced catholyte. The diffused protons across the proton exchange membrane combine with oxygen and electrons to regenerate catholyte and release water in the cathode chamber. The MEA consists of a pair of electrodes disposed either side of a proton exchange membrane (or polymer-electrolyte membrane, PEM). One electrode being in contact with anode chamber and the other electrode in contact with the cathode chamber.

Within the prior art μPSCs have been reported as being fabricated using silicon micromachining techniques where one side of a silicon wafer is etched (patterned) to make multiple cells and to be used as the base for the electrodes which are fabricated by sputtering chrome and gold with approximate overall thickness of 2500 [symbol] over the patterned silicon. The PEM is then sandwiched between two such silicon cells and electrolytes. Accordingly, silicon micromachining techniques employing dean room environment etc. were required, Within U.S. Pat. No. 10,615,440 an alternate Methodology was employed wherein the electrodes were deposited and patterned onto the PEM. Accordingly, whilst this design methodology allowed the anode and cathode chambers to be formed from other materials such as polymeric materials, which can result in faster, cheaper, and more efficient fabrication methods and elimination of some chemicals and processes (including the use of dean room facilities, which are required for silicon fabrication processes) the overall μPSC still requires semiconductor processing techniques for forming the electrodes upon the PEM.

Accordingly, the inventors have established a new design approach which eliminates the requirements for photolithography completely to define the electrodes either upon silicon wafers or the PEM.

The anode and cathode chambers may be formed from one or more materials although polymeric materials are particularly well suited due to their low cost, ability to be injection molded or stamped, inert properties to biological organisms, etc. In some embodiments, a particular polymer, e.g. polydimethylsiloxane (PDMS), may be used for the main body of the device. However, it is to be understood that other materials could be used for fabricating the main body of the device comprising the anode and cathode chambers. Alternative materials, may include, but not be limited to plastics, glass, plexiglass, poly methyl methacrylate (PMMA), epoxy based photoresists (e.g. SU8), photoresist, silicone, polyvinyl alcohol (PVA), polyethylene oxide (PEO), polyimide (PI) or any polymer material that can be used in micro fluidics.

Embodiments of the invention include a μPSC having at least two main body portions and a proton exchange membrane (PEM) sandwiched between the at least two main body portions. The main body portions are fabricated to each include a reaction chamber, a desired number of inlets, outlets and fluidic channels between the reaction chambers and inlets and outlets. The inlets and outlets may be used to supply and/or extract different fluids such as, but not limited to, live cultures, mediators and glucose, and/or gases, such as oxygen or carbon dioxide, to or from the reaction chambers.

A portion of at least one of the at least two main body portions is optically transparent. In some embodiments, the main body portion has an opening in proximity to the reaction chamber to allow the reaction chamber, and contents therein when the reaction chamber is full, to be exposed to the light. The opening may be covered with a glass cover. In some embodiments there is no physical opening, but the main body portion still includes an optically transparent window for light to access the reaction chamber. For example, the material used to fabricate the main body portion is optically transparent and in the area of the window the material may be thinner than other areas to reduce optical attenuation.

In some embodiments, some form of mechanism is attached to the μPSC at the locations of the inlets and outlets to control the volume of fluids being supplied to, or removed from, the μPSC. In some embodiments this may be precision tips, as shown in some of the figures below, but other mechanisms are contemplated as well. In some embodiments a peristaltic pump may be used for Supplying/extracting fluids and/or gases, to the LPSC. In some embodiments the peristaltic pump, a syringe pump or other type of pumping device including, for example, a micro-pump, may be used for circulating fluids/gases in and out of the μPSC.

Underlying the design of the μPSC is the concept of interfering with the electron transfer chain through an external load and guide electrons in the desired direction to obtain electrical current. FIG. 1 shows electrons following a path away from the anode electrode towards the external load (light bulb), and then toward the cathode electrode. A solution in the anode chamber is an anolyte solution. A solution in the cathode chamber is a catholyte solution. In the anode chamber, after absorption of photons, electrons (e) are released in the anolyte solution and are taken up by the anode electrode. The electrons are transferred through the external circuit and the associated external load to the cathode electrode in the cathode chamber where they are reduced by the catholyte solution. This transfer of electrons creates a proton gradient which is balanced by the PEM. In some embodiments the PEM is a sulfonated polymer. Other types of PEM include, but are not limited to, sulfonated tetrafluoroethylene based fluoropolymer-copolymers (e.g. those marketed under the Nafion® brand), sulfonated αββ-trifluorostyrene-co-substituted-αββ-trifluorostyrenes (e.g. those marketed under the BAM® brand), sulfonated styrene-(ethylene-butylene)-styrene triblock copolymers (e.g. those marketed under the DAIS® brand), and sulfonated styrene-(ethylene-butylene)-styrene triblock copolymers (ETFE-g-PSSA).

In some embodiments, the first reaction chamber contains an anolyte solution including live photosynthetic micro-organisms. A non-exhaustive list of possible photosynthetic micro-organisms includes green algae, red algae, eukaryotic algae, chrysophytes, thylakoid, phytoplanktons, cyanobacteria, green sulfur bacteria, purple sulfur bacteria, purple non-sulfur bacteria or other photosynthetic bacterium, diatoms, plant tissue, chlorophyll, chloroplasts. The anolyte solution may consist of whole cells or separated pigments; in all cases it contains micro-organisms. In some embodiments the anolyte solution includes growth media. In some embodiments, the anolyte solution includes mediator including, for example, methylene blue, neutral red and thionine acetate.

In some embodiments, the anolyte solution includes glucose or any chemical to be used as food source for respiration. In some embodiments photosynthetic agents can be directly integrated on anode or can be contained in a corresponding growth media (e.g. high salt medium (HSM) or CHU). In some embodiments, the second reaction chamber contains a catholyte solution including a ferrocyanide ion solution, for example, but not limited to potassium ferrocyanide, for use as an electron acceptor. More generally, the catholyte is an electrochemically active compound with high tendency of absorbing electrons. A non-exhaustive list of possible catholyte solutions includes thionines, viologens, quinones, phenazines, phenoxazines, phenothiazines, iron cyanide, ferric chelate complexes, ferrocene derivatives, dichlorophenolindophenol, and diamino durene.

While particular examples of the PEM material, anolyte solution and catholyte solution are given above, it is to be understood that these are merely for the sake of example and the PEM material, anolyte solution and catholyte solution are implementation specific. Further, FIG. 1 depicts an exemplary configuration of how two reaction chambers are coupled together to form a simple power cell having a single set of anode electrodes and a single set of cathode electrodes. In some embodiments of the invention multiple reaction chambers could be stacked one on top of another with a respective PEM between each adjacent pair of reaction chambers.

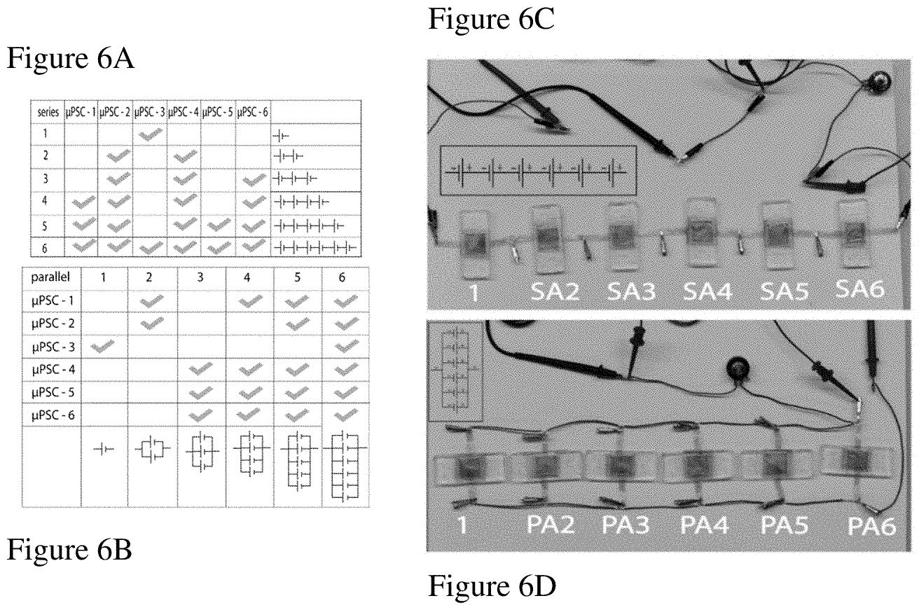

However, the μPSC even with the exploitation of polymeric materials for the chambers etc. still requires the micro-fabrication of electrodes upon the PEM as evident from FIGS. 6A and 6B of U.S. Pat. No. 10,615,440. Accordingly, as noted above it would be beneficial to remove this micro-fabrication processing involving cleanroom environments and processing sequences involving photolithography, thin film deposition and etching upon both sides of the PEM.

Accordingly, the inventors have established a μPSC device consisting of two half-cells, each forming the anode and the cathode separated by a proton exchange membrane (PEM). Within the following embodiments of the invention the PEM employed was Nafion-117 (hereinafter referred to as Nafion) which was treated before being utilized. A gold coated aluminum arrayed grid-foil of thickness 100 μm was employed. Within prototypes the 2.4×2.4 cm² aluminum metal arrayed grid-foils were sputtered with 40 nm gold on both the surfaces although it would be evident that other deposition processes such as electro-plating may be employed to support large areas of arrayed grid-foil or metalizing rolls of the arrayed grid-foil. The arrayed grid-foil may, for example, be an expanded metal foil formed by stamping a foil.

Whilst aluminum was employed within the prototypes devices it would be evident that other materials including, but not limited to, copper, nickel, stainless steel, titanium etc. may be employed. Within embodiments of the invention mesh dimensions may, for example, be within the range 50 μm to 250 μm although other dimensions may be employed. The open area of the arrayed grid-foil may, for example, be within the range of 25% to 95% although other open area percentages may be employed.

The Nafion was treated in accordance with the process described by M. Shahparnia within “Polymer Micro Photosynthetic Power Cell: Design, Fabrication, Parametric Study and Testing” (Master's Thesis, Concordia University, 2011). The Nafion was incubated at room temperature for 12-14 hours to reduce its humidity content. The metal electrodes (gold coated aluminum arrayed grid-foils) were bonded to the Nafion using a water-resistant adhesive (electrically non-conductive) and force of 1.3 kN was applied for about 1 hour for the strong bonding of the metal electrodes to the Nafion. Electrodes of sizes 0.5×3 cm metal electrodes were bonded to both the sides of the membrane electrode assembly, to connect to the external resistor (circuit). Polymer PDMS was utilized for the anode and cathode chambers where a 10:1 PDMS and curing agent ratio was mixed and degassed for 10 minutes to remove all the air bubbles from the PDMS mixture. A brass mold was used for the casting to prepare the anode and cathode chambers. The PDMS was poured in the brass mold and incubated at 60° C. for 4 hours. Finally, PDMS mixture in the ratio (10:1) was used for the final bonding of membrane electrode assembly and the anode and cathode chambers. A force of 1.3 kN was applied and the sample was kept in the oven at 60° C. for 4 hours. The cathode chamber was covered with a microscopic cover glass attached with an adhesive.

It would be evident that the anode/cathode chambers may be formed from a variety of materials without departing from the scope of the invention. Within other embodiments of the invention the MEA (comprising PEM and pair of electrodes) may be soldered, cold-welded etc. to the anode/cathode chambers according to their composition and/or coating. Within other embodiments of the invention other methods of attaching the electrodes to the PEM may be employed. Within other embodiments of the invention through alternate processing methodologies the pair of electrodes may be attached a central non-conductive element of similar geometry (i.e., perforated or latticed) and the PEM formed within the open areas of the dual electrode-spacer assembly through techniques such as dip coating etc.

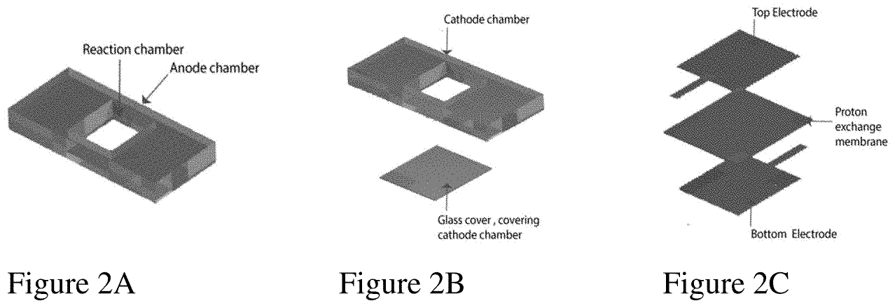

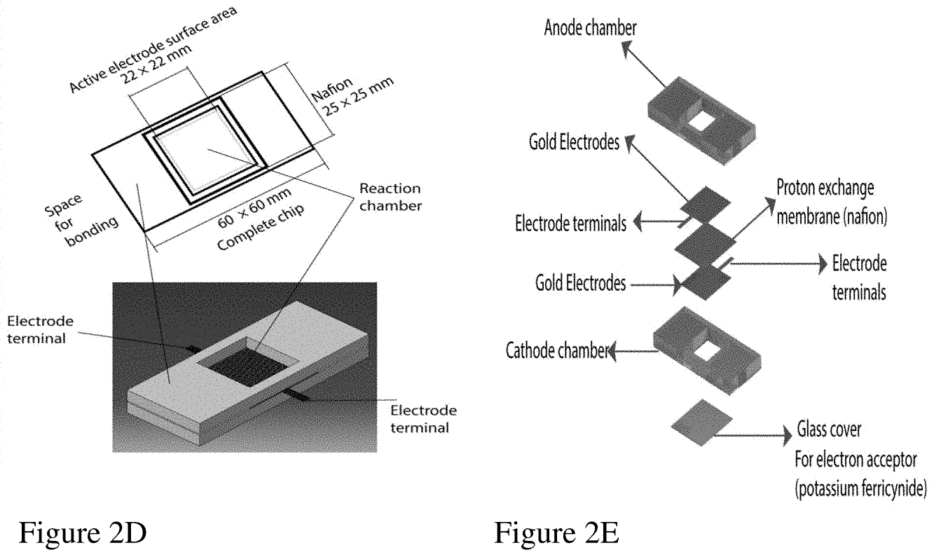

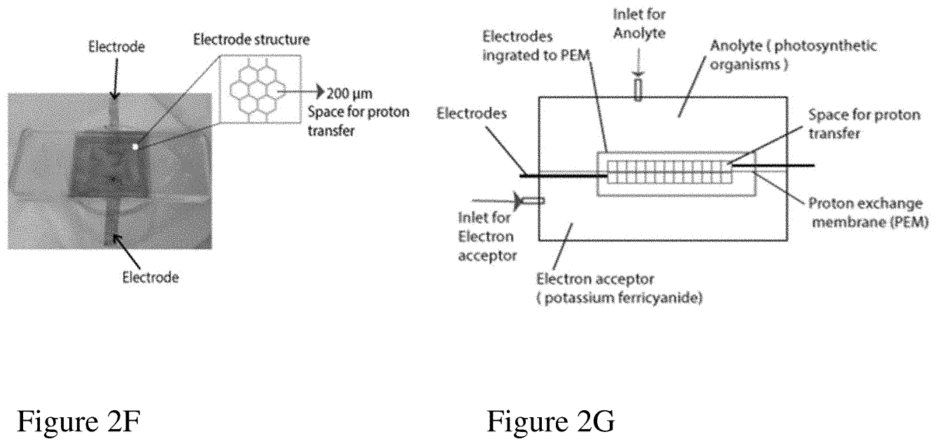

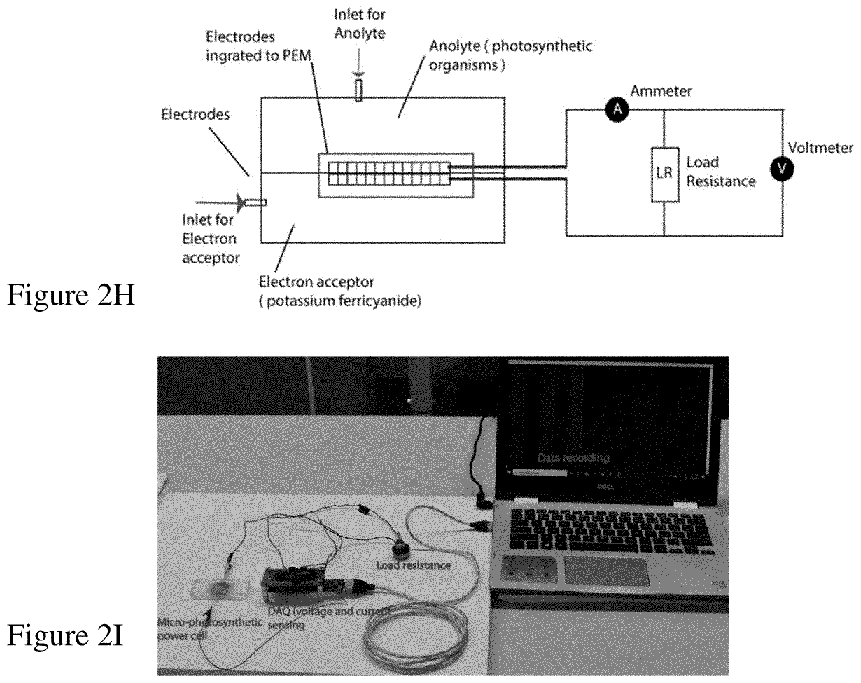

Referring to FIGS. 2A to 21 respectively there are depicted the components and assembly of prototype μPSCs according to embodiments of the invention. Accordingly:
FIG. 2A depicts the anode reaction chamber prepared using polydimethylsiloxane (PDMS);
FIG. 2B depicts the cathode chamber and the cover glass which was used to seal to hold the electron acceptor (potassium ferricyanide);
FIG. 2C depicts the arrayed grid-foil bonding of the top and bottom electrodes to the proton exchange membrane (PEM), Nafion 117, to form the MEA where one arrayed grid-foil acts as the anode electrode and the other arrayed grid foil acts as the cathode electrode;
FIG. 2D depicts the dimensions of a single μPSC prototype according to an embodiment of the invention where the active electrode surface area is 4.84 cm² (22 mm×22 mm);
FIG. 2E depicts an exploded assembly of a μPSC according to an embodiment of the invention;
FIG. 2F depicts a final assembled optical micrograph of a μPSC according to an embodiment of the invention with an insert depicting the structure of the arrayed grid-foil allowing space for proton transfer through the hexagonal openings with a diagonal of approximately 200 μm (approximately 0.008″);
FIG. 2G depicts a detailed schematic view of a μPSC according to an embodiment of the invention with inlet for photosynthetic microorganisms in the anode chamber and electron acceptor in cathode chamber;
FIG. 2H depicts a schematic view of a μPSC according to an embodiment of the invention connected to the external electrical loading; and
FIG. 2I depicts an optical micrograph of a μPSC according to an embodiment of the invention connected to an external electrical load and data logging to computer through a data acquisition (DAQ) system.

Assessment of μPSCs according to embodiments of the invention were performed under varying illumination with a current measuring unit (e.g., multimeter) whilst the terminal voltage of the μPSC, was measured through the DAQ system. Accordingly, the power of the μPSC was obtained by multiplying the measured terminal voltage and measured load current of μPSC. Brass alligator clips served for the connections of the prototype μPSC according to embodiments of the invention.

Polarization characteristics were obtained by recording the terminal voltage by varying the variable resistor. The variable resistor was tuned to change the load current from maximum to minimum and their corresponding terminal voltage was recorded. Within the experiments performed upon prototype μPSC according to embodiments of the invention the load resistance was varied from 0 to 50 kΩ. The internal resistance of the current measuring circuit was taken into consideration in the loading. Each load current and terminal voltage recording were performed after the readings had stabilized, which was less than 30 seconds.

Artificial light was provided by the white, fluorescent bulb of 15 Watts maintained at constant light illumination at the μPSC location. Light levels were controlled such that different light intensities could be generated. The light intensities were measured with lux meter and further converted to μEm⁻²s⁻¹. In order to establish a dark condition all light sources in the area of the experiment were switched off and a thick cardboard box employed over the top of the μPSC. For the LED tests described below the test set up was moved to specialized dark room and the testing were performed.

The individual μPSC cell components were assembled, and the necessary reactants/solutions are prepared. 2 ml of 25% (w/v) potassium ferricyanide (K₃[Fe(CN)₆]) solution was prepared and used as the catholyte in the cathode chamber. The anode chamber was filled with 2 mL of the anolyte solution (algal solution) containing green algae (Chlamydomonas reinhardtii) in their exponential growth phase. A room temperature of approximately 23° C. was maintained for all tests.

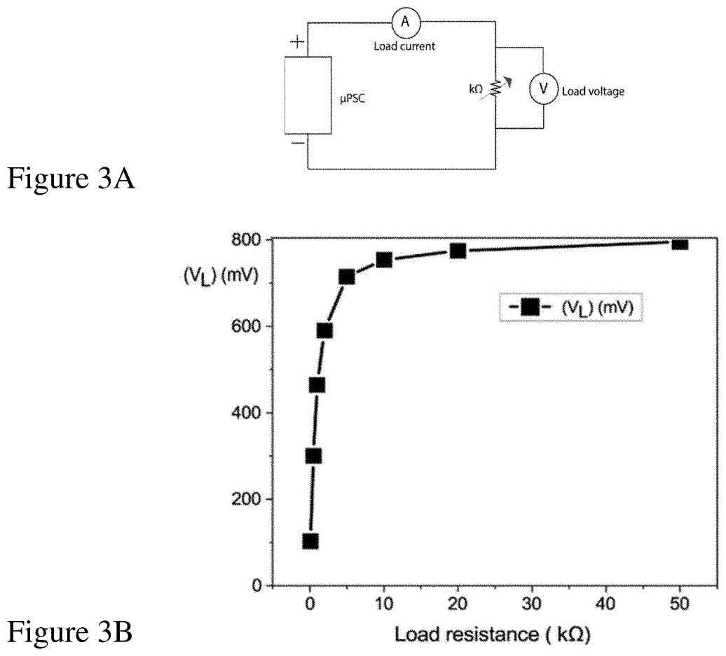

Performance of Prototype μPSC under light illumination of 2 μEm⁻²s⁻¹ (147 lux) was initially performed. The following measurements were performed:
Open Circuit Voltage (V_{OC}): The μPSC under the said operating conditions demonstrated a V_{OC} of 810 mV. The V_{OC} was measured for 30 minutes without significant variation being observed during the investigation.
Short Circuit Current (I_{SC}): An I_{SC} of 800 μA was observed with the single μPSC.
Electrical Loading: In order to observe the performance of μPSC under real-time electrical loading conditions, several electrical loading such as 0.1, 0.5, 1, 2, 5, 10, 20, and 50 kΩ were tested with the μPSC. The plot of variation of the load voltage (V_{L}) and load current (I_{L}) is depicted in FIG. 3B.
Load voltage (V_{L}) and load current (I_{L}): FIG. 3A shows the schematics of V_{L} and I_{L} measurements from the μPSC whilst FIG. 3B depicts the measured V_{L} of the μPSC according to an embodiment of the invention under the electrical loadings.

As evident from FIG. 3B the μPSC according to an embodiment of the invention generated a V_{L} of 103 mV at a load of 0.1 kΩ, and at 50 kΩ, a V_{L} of 795 mV. At a loading of 1 kΩ, the μPSC according to an embodiment of the invention generated a load voltage of 465 mV. It was observed that the increase in load voltage from 5 kΩ to 50 kΩ was relatively small. Similarly load currents at different load resistances were measured.

To observe the performance of the μPSC according to an embodiment of the invention in different light illumination and dark condition, three different light conditions such as 2 μEm⁻²s⁻¹ (147 lux), 8 μEm⁻²s⁻¹ (595 lux) 20 μEm⁻²s⁻¹ (1500 lux) were illuminated uniformly on the μPSC test location. The μPSC was exposed to these light illuminations for 30 minutes, and then the electrical performance recorded. After the three light conditions, the μPSC was investigated with a short period of dark conditions (less than 5 minutes). No significant difference in performance as that of light conditions was observed. To mimic a natural system of day and night (light and dark cycles), the μPSC was exposed to dark conditions for 30 minutes and light conditions for 30 minutes to observe the electrical performance.

The effect of light Illumination on the V_{OC}, I_{SC}, V_{L}, and I_{L} from these measurements are discussed here. Amongst the three light illuminations chosen in this study, the light illumination 2 μEm⁻²s⁻¹ demonstrated a higher V_{OC} of 818 mV compared to other light illuminations, which showed V_{OC} of 750 and 760 mV. For the light illumination of 2 μEm⁻²s⁻¹, μPSC demonstrated a maximum I_{SC} of 1000 μA compared to other light illuminations. For the light illuminations of 8 μEm⁻²s⁻¹, the I_{SC} was observed to be 713 μA, and for the 20 μEm⁻²s⁻¹ it was found to be 630 μA, indicating an impact of the light illumination on the I_{SC}. For the dark conditions, the I_{SC} was observed to be 430 μA, which is 55% less than that from the light illumination of 2 μEm⁻²s⁻¹. For the light illumination of 2 μEm⁻²s⁻¹ a maximum V_{L} of 470 mV was observed. In contrast for the light illumination of 8 μEm⁻²s⁻¹ and 20 μEm⁻²s⁻¹ V_{L} of 400 and 356 mV were observed, respectively. For the dark condition, the V_{L} dropped to 280 mV, which is almost 40% decreases in comparison to the light illumination 2 μEm⁻²s⁻¹. Similar observations were made with load current at 1 kΩ. The highest I_{L} of 460 μA was observed for the light illumination of 2 μEm⁻²s⁻. For the light illumination of 20 μEm⁻²s⁻¹ I_{L} of 356 μA was observed. For the dark condition, I_{L} was reduced, and it was found to be 280 μA, which is 40.4% lower than the light illumination of 2 μEm⁻²s⁻¹.

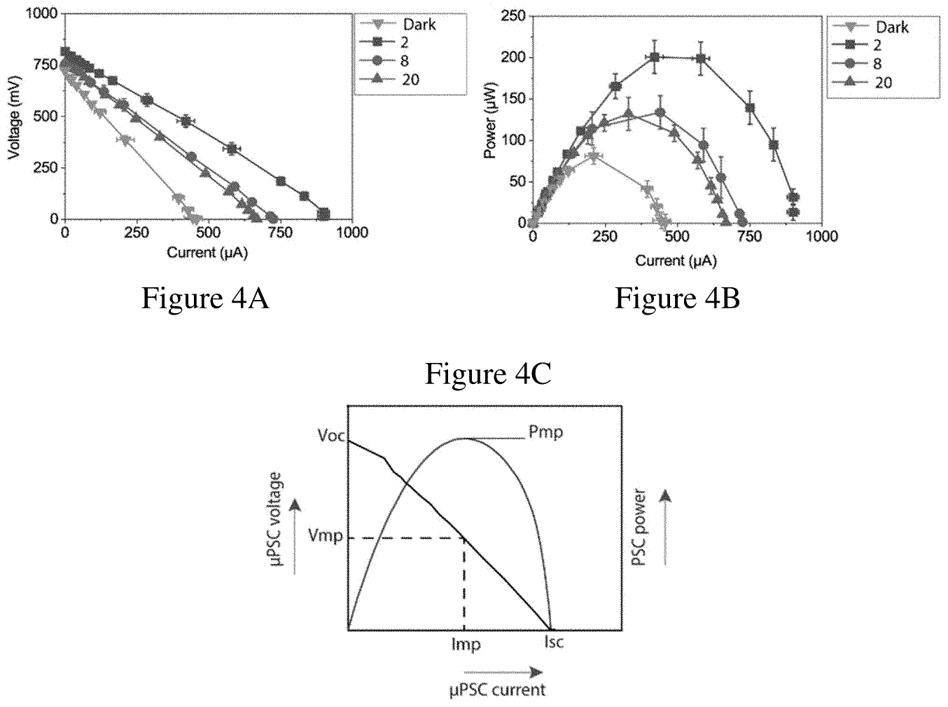

The effect of light and dark condition on current-voltage (I-V) and current-power (I-P) characteristics of μPSC according to an embodiment of the invention were also assessed by recording I-V and I-P characteristics of the μPSC at different light conditions. The light illumination of 2 μEm⁻²s⁻¹ has shown a higher area under the curve than the other light conditions. The dark condition was almost half the area of the light illumination 2 μEm⁻²s⁻¹. FIG. 4A depicts the I-V characteristics of all light illuminations and dark conditions for the μPSC according to an embodiment of the invention. FIG. 4B depicts the I-P characteristics of μPSC according to an embodiment of the invention in different light illumination and dark condition. FIG. 4C depicts a schematic representation of V_{OC}, I_{SC}, Vₘₚ, Iₘₚ, and Pₘₚ Table 1 below summarises the performance of the V_{OC} and I_{SC} of the μPSC according to an embodiment of the invention in all light illumination and dark condition. Table 2 below summarises the performance of Iₘₚ and Pₘₚ of μPSC according to an embodiment of the invention in all light illumination and dark condition.

TABLE 1
V_{OC} and I_{SC} variations with light illumination and dark condition.

| Illumination | | |
|---|---|---|
| (μEm⁻²s⁻¹) | V_{OC} (mV) | I_{SC} (μA) |
| Dark | 724 | 430 |
| 2 | 818 | 1000 |
| 8 | 750 | 713 |
| 20 | 760 | 630 |

TABLE 2
I_{MP} and P_{MP} variations with light illumination and dark condition.

| Illumination | | |
|---|---|---|
| (μEm⁻²s⁻¹) | I_{MP} (μA) | P_{MP} (μW) |
| Dark | 210 | 81.27 |
| 2 | 420 | 200.76 |
| 8 | 440 | 133.76 |
| 20 | 247 | 121.03 |

The inventors fabricated twelve μPSCs, μPSC-1 to μPSC-12, according to the embodiment of the invention as described above with respect to FIGS. 2A to 2G wherein the μPSCs, μPSC-1 to μPSC-6, were used to evaluate Series Array (SA6) and Parallel Array (PA6) configurations. Table 3 outlines the performance all twelve μPSCs fabricated according to an embodiment of the invention. The other μPSCs, μPSC-7 to μPSC-12, employed to form combinatory array combinations.

| | V_{OC} | Variation | I_{SC} | Variation |
|---|---|---|---|---|
| | (mV) | (+) (mV) | (μA) | (+) (μA) |
| μPSC-1 | 775 | 12 | 400 | 6 |
| μPSC-2 | 730 | 12 | 534 | 6 |
| μPSC-3 | 810 | 15 | 1220 | 15 |
| μPSC-4 | 720 | 12 | 800 | 10 |
| μPSC-5 | 800 | 15 | 460 | 6 |
| μPSC-6 | 770 | 12 | 410 | 6 |
| μPSC-7 | 800 | 15 | 930 | 10 |
| μPSC-8 | 770 | 12 | 820 | 10 |
| μPSC-9 | 806 | 12 | 530 | 6 |
| μPSC-10 | 810 | 15 | 600 | 6 |
| μPSC-11 | 700 | 12 | 360 | 6 |
| μPSC-12 | 800 | 15 | 815 | 10 |

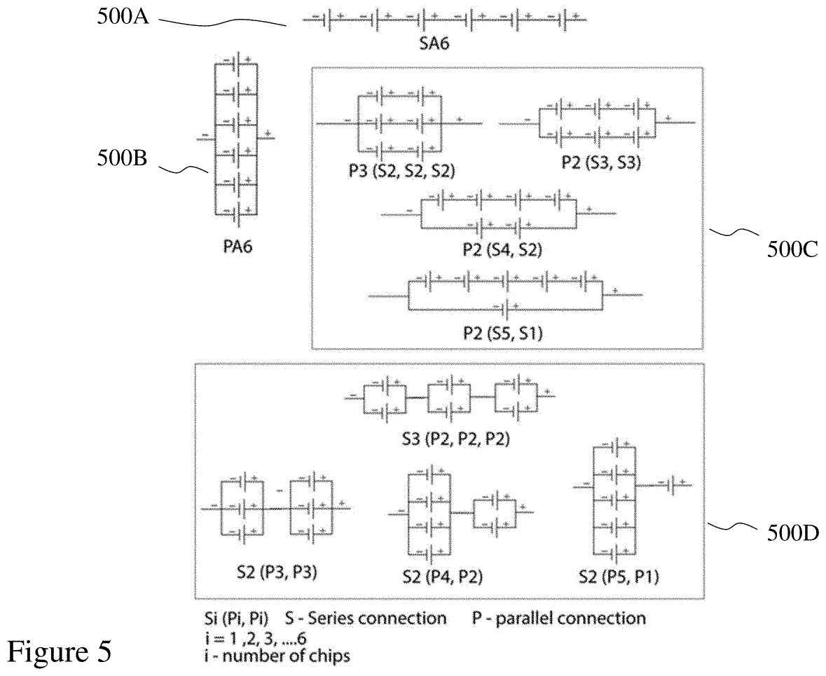

FIG. 5A depicts first to fourth images 500A to 500D respectively, wherein
First image 500A depicts the SA6 configuration;
Second image 500B depicts the PA6 configuration;
Third image 500C depicts a first series of combinatory configurations (CC-1) comprising P3 (S2,S2,S2), P2 (S3,S3), P2 (S4,S2), and P2 (S5,S1); and
Fourth image 500D depicts a second series of combinatory configurations (CC-2) comprising S3 (P2,P2,P2), S2 (P3,P3), S2 (P4,P2), and S2 (P5,P1)]).

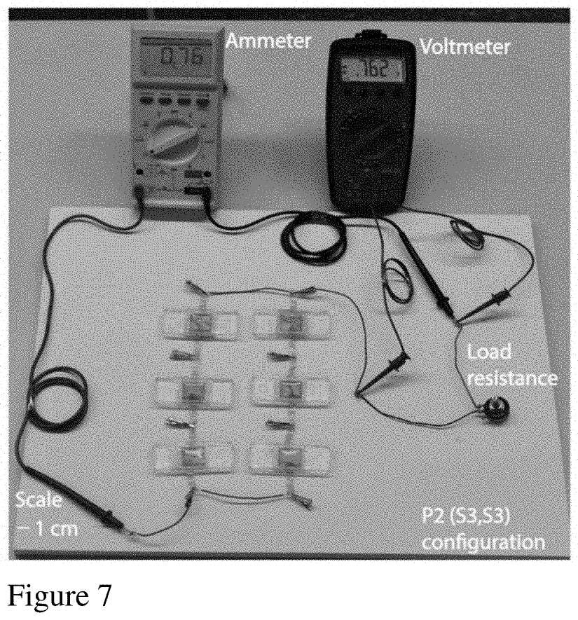

FIGS. 6A and 6B depicts the SA6 and PA6 configuration of the μPSCs according to an embodiment of the invention. FIGS. 6C and 6D depict optical micrographs of the SA6 and PA6 configurations. Whilst FIG. 7 depicts an experimental configuration for measuring current and voltage characteristics of arrays of μPSCs according to embodiments of the invention it also shows one combinatory configuration, namely P2 (S3,S3).

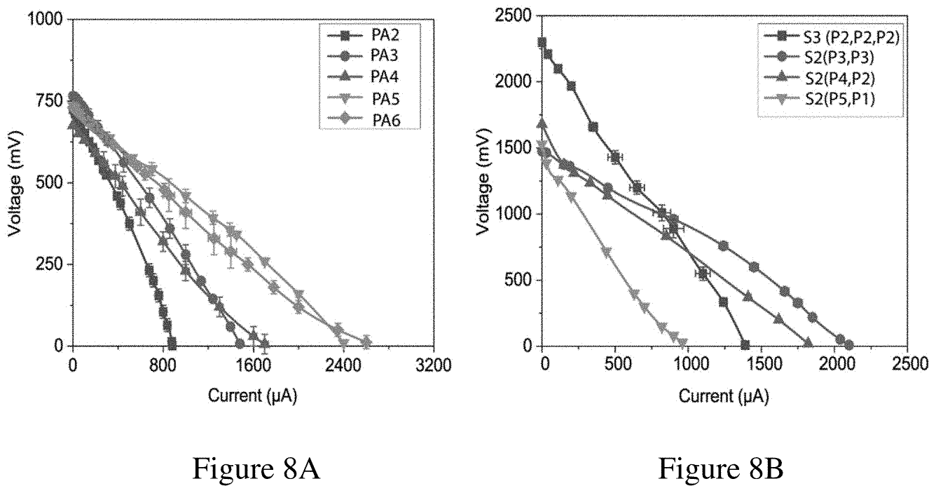

The inventors then observed the performance of μPSC under real-time loading conditions, load test at 1 kΩ and 0.5 kΩ were performed for all array configurations. Initially the I-V characteristics of array configurations were measured wherein:
FIG. 8A depicts the polarization curve of μPSCs according to embodiments of the invention in the PA2 to PA6 parallel array configurations;
FIG. 8B depicts the polarization curve of μPSCs according to embodiments of the invention in the CC-2 configurations performances.

Within the AA6 configuration the voltage increased with increasing the number of μPSCs and the current remained as the lowest μPSC's current. In FIG. 8A the polarization curves of the PA6 configurations of μPSCs are depicted where the voltage similarly remained the same but in contrast to the SA6 configuration the current increased by increasing the number of μPSC.

In FIG. 8B the polarization curves of the CC-2 configurations are depicted. As evident the combination S3 (P2,P2,P2) and S2 (P3,P3) demonstrated a higher area under their I-V curves than the combinations S2 (P4,P2) and S2 (P5, P1).

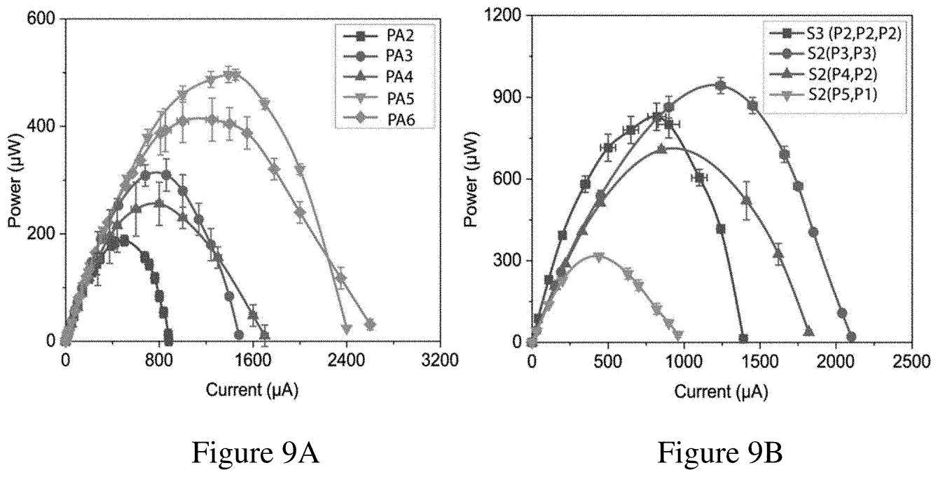

Next the I-P characteristics were evaluated. Within the SA6 configuration, with the increase in the number of μPSCs the power increased. Referring to FIG. 9A the power-current characteristics of the PA6 configurations are depicted. The arrays of 5 and 6 μPSCs respectively in parallel connection demonstrating the higher maximum powers. The maximum power up to 500 μW and current in the configurations of 2700 μA was established in this configuration. Therefore, in the parallel configuration power and current have increased. However, the voltage of these remains approximately that of the lowest individual μPSC voltage.

In contrasts, referring to FIG. 9B there are depicted the power-current characteristics of the CC-2 configurations. The combinations S3 (P2,P2,P2) and S2 (P3,P3) have demonstrating maximum power. In comparison with all the four array configurations, CC-1 and CC-4 configurations, the combinations P3 (S2,S2,S2) and P2 (S3,S3) were shown to perform with higher maximum power and current and with higher terminal voltage. Therefore, for most real world deployment configurations the inventors have established that a deployed μPSC configuration should comprise a combination of series and parallel elements for power enhancement.

Subsequently, the maximum power and operating points for μPSCs according to embodiments of the invention were established for discrete and array configurations. The power density of the four array configurations relative to the single μPSC are given in Table 4 below.

TABLE 4
Maximum Power Density for Discrete and Arrayed μPSCs according
to Embodiments of the Invention.

| | Maximum | | |
|---|---|---|---|
| | Power Density | | Electrode Area |
| Configuration | (Pₘₚ) (mWm⁻²) | Pₘₚ (mW) | (cm²) |
| Single μPSC | 413.2 | 0.19 | 4.84 |
| SA6 | 979.9 | 2.8 | 29.04 |
| PA6 | 1025.2 | 2.97 | 29.04 |
| CC-1 [P2 (S3, S3)] | 1289.2 | 3.74 | 29.04 |
| CC-2 [S2 (P3, P3)] | 1914 | 5.5 | 29.04 |

When considering application of μPSCs according to embodiments of the invention then amongst the applications are sensors, e.g., so-called “Internet of Things” (IoT) sensors which require low and ultra-low power operation with intermittent power “intensive” modes. For example, sensors such as humidity sensors, weather monitoring sensors and many other low power electronic devices such as biosensors are typically required to perform a measurement and transmit it within a short period of time interspersed with long periods of dormancy (i.e., sleep mode with ultra-low power consumption). Accordingly, to access the reliability of the array of μPSCs a pair of light emitting diodes (LEDs) with rating 2 V, 2 mA, and 1.7 V, 2 mA respectively were powered successfully for periods of 4 to 6 hours from μPSCs according to embodiments of the invention.

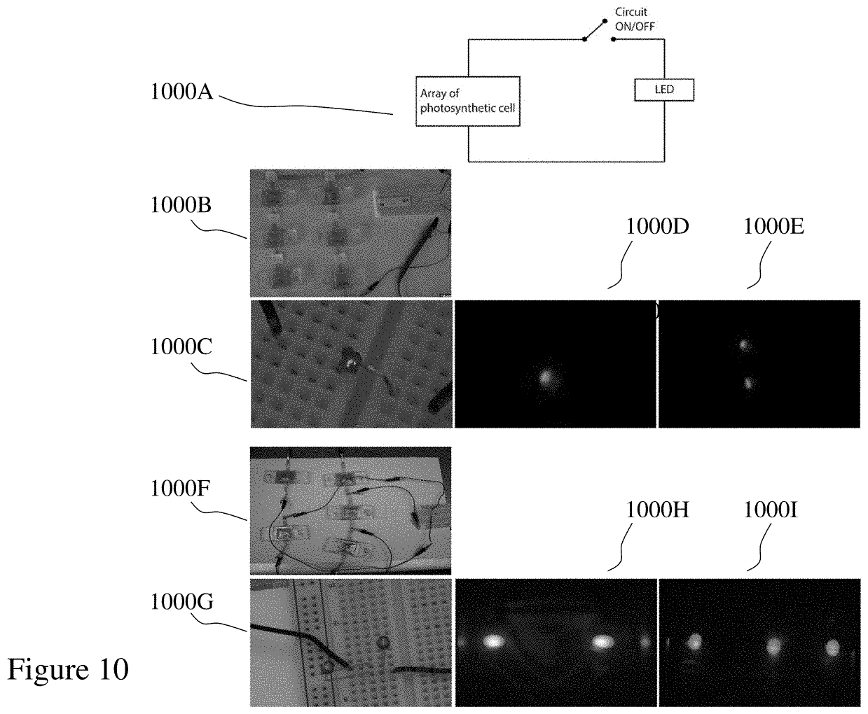

First image 1000A in FIG. 10 depicts a schematic of the circuit connection of LED(s) to the μPSCs according to embodiments of the invention. Second image 1000B in FIG. 10 shows the array of μPSC combinations employed for LED testing whilst third and fourth images 1000C and 1000D depict the operating LED with the μPSCs according to embodiments of the invention illuminated whilst fifth image 1000E shows the LED operation with the μPSCs according to embodiments of the invention in the dark.

In a second case, only five μPSCs were utilized comprising three μPSCs in series connection and another set of two μPSC in series connection. Further, both the sets were connected in parallel connection to get the desired voltage and current for the LED. Here the effective voltage was observed to be 1.72 V and the current was 1.8 mA. Therefore, the LEDs glowed with high illuminance. Further to test the potential of the array configuration, a total of 3 LEDs were connected in parallel connection, and all three LEDs were lit by the array of μPSCs. Sixth image 1000F shows the array of μPSC combinations employed for LED testing whilst seventh and eighth images 1000G and 1000H depict the operating LEDs with the μPSCs according to embodiments of the invention illuminated whilst ninth image 1000I shows the LEDs operation with the μPSCs according to embodiments of the invention in the dark.

In addition to this, in both the cases LEDs were tried to be lit in the dark conditions as well. In the dark conditions, within a short time interval, their terminal voltage and current remained the same as that of light conditions. In our previous tests, it was found that after 30 minutes of dark condition the terminal voltage and current of the μPSC reduced slightly. In both cases, LEDs were lit in dark conditions as well. In the second case, the two LEDs were lit up to 4 hours without variation in the terminal voltage and current. The process of connection and disconnection of the circuit were repeated several times demonstrating reproducibility.

It would be evident that in some applications high power provisioning from μPSCs according to embodiments of the invention may be required rather than lower power utilizations such as sensors etc.

The current fabricated μPSCs according to embodiments of the invention in prototype form have an active electrode surface area of 4.84 cm². By considering extra the space of 5.16 cm² for the efficient bonding of anode and cathode chambers for the fabrication of the μPSC, the total area of a single μPSC according to prototype embodiments of the invention would be 10 cm². Above, six μPSCs according to embodiments of the invention were utilized for array configurations. In these studies, it was found that the predicted values in the case P2 (S3,S3) configuration has almost those of the experimental values. Therefore, considering this configuration as an efficient strategy for the real time application, the model was extended by the inventors. Accordingly, in one-meter square area (10,000 cm²) one can fit 1000 μPSCs according to the prototype design within the array. Based on the simulations and experimental data, it was found that the P2 (S3,S3) is the optimal configuration to increase both voltage and current, which increases the maximum power.

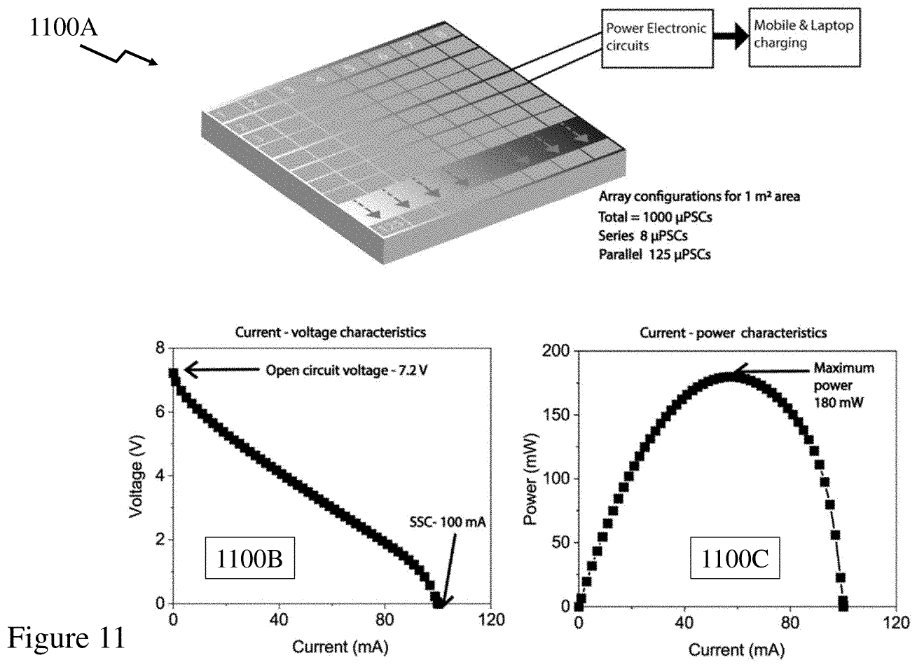

Currently, charging in many mobile battery applications for electronic devices typically requires a voltage of 5 V where their battery charging depends upon the ampere hour rating and further rate of the charging depends on the value of the current. Therefore, considering these real world applications, for the 1 m² area one can assemble 1000 μPSCs. Based on the current knowledge of array combinations P2 (S3,S3) has generated maximum power and highest load voltages and currents. Accordingly, a similar configuration was chosen where eight μPSCs were connected in series connection, their effective voltage was found to be 7.2 V and current was found to be 0.8 mA. The number of 8 μPSCs was chosen, considering ohmic losses in the circuit connection. To increase the current, 125 sets of such arrays of μPSCs would be connected in parallel. Accordingly, in this configuration the current output would be 100 mA with voltage 7.2 V. Considering a battery capacity of 2000 mAh it would take about 20 hours for complete charging and a battery with capacity 4000 mAh would 40 hours for complete charging. However, all the conditions are ideal cases. considering the ohmic losses and assuming all the μPSC performance is identical would be 7.2 V and 100 mA. First image 1100A in FIG. 11 depicts an exemplary large area array exploiting μPSCs according to embodiments of the invention comprising 125 parallel μPSC arrays each comprising 8 μPSCs in series. Second and third images 1100B and 1100C in FIG. 11 depict projected I-V and current-power characteristics of the array combination for 1 m ² area using μPSCs according to embodiments of the invention.

The μPSCs, μPSC-7 to μPSC-12, were subsequently disassembled and cleaned with deionized water after the removal of anolyte and catholyte. Further, the μPSCs were carefully cleaned with soft absorbents on both anode and cathode sides. After 3 days new algae cultures were prepared and used for testing. The LEDs were again lit and no significant difference in the μPSC performance was observed compared to their previous performances.

Several array configurations such as series and parallel and combinations of series and parallel configurations have been described above. The model photosynthetic microorganism utilized was Chlamadomonaous reinhardtii which was used as a whole liquid culture of green algae, the longevity of the cell viability was higher. The design of μPSCs with better flow regimes would make the photosynthetic microorganism self-repairing and generate power continuously. Therefore, with this, the exemplary μPSCs according to embodiments of the invention have the potential for scale-up and could be used in commercial energy production for low power applications.

The power output density of 1914 mWm⁻² can be used to power most commercially available ultra-low-power sensors such as humidity sensors, ultrasonic sensors, global positioning systems whose power requirements range from fractions of a milliwatt (e.g., 0.15 mW) to tens of milliwatts (e.g., 60 mW). Further, as many IoT sensors require power for very shorts period with long periods of inactivity at ultra-low power then IoT ultra-low power sensors can be operated continuously in conjunction with μPSCs according to embodiments of the invention both in light and dark conditions. Suitable power converters may be required to charge batteries, e.g., rechargeable batteries, from μPSCs according to embodiments of the invention

The prototype μPSCs according to embodiments of the invention have demonstrated electrical performance of the μPSC for several hours. However, this may be extended to continuous operation by designing an external fluidic (or microfluidic) system to provide the continuous flow of anolyte to the anode chamber and catholyte to the cathode chamber.

The materials used in the fabrication such as the proton exchange membrane (Nafion), the aluminum metal arrayed grid-foils etc. are environmentally friendly and are biodegradable or recyclable unlike photovoltaics which takes several hundreds of years for biodegradation.

Within the embodiments of the invention described above the electrodes disposed either side of the PEM are formed from an aluminum arrayed grid-foil aluminum coated with gold. Within other embodiments of the invention the arrayed grid-foil may be formed from other conductive materials including, but not limited to, a metal, an alloy, a conductive polymer, a conductive ceramic, and graphite. With respect to the arrayed grid-foil then this may be formed within embodiments of the invention, for example, by mechanically penetrating a continuous foil wherein the penetration forms the openings and mechanical action of the penetrating head and/or elements attached to the foil expand the openings in a single axis or dual axes within the plane of the foil to establish the desired dimensions and geometry. Accordingly, within other embodiments of the invention the arrayed grid-foil may be formed from a ductile metal or metals such as aluminum, copper, nickel, silver, titanium, zirconium, niobium, zinc, and gold for example. Accordingly, within other embodiments of the invention the arrayed grid-foil may be formed from a ductile alloy such as stainless steel, iron-chromium-aluminium (FeCrAl) alloys, low carbon steel, austenitic nickel-chromium-based alloys. Accordingly, within other embodiments of the invention the arrayed grid-foil may be formed from a ductile polymer such as ethylene chlorotrifluoroethylene (ECTFE), ethylene tetrafluoroethylene (ETFE), fluorinated ethylene propylene (FEP), polyether ether ketone (PEEK), perfluoroalkoxy alkanes (PFA), and polytetrafluoroethylene (PTFE). Accordingly, within other embodiments of the invention the arrayed grid-foil may be formed when a material is ductile during its manufacturing process but is not ductile once fabrication has completed such as, for example, a glass, metal, alloy or polymeric material wherein the array of openings are formed when the material is at a temperature such that the material is ductile (e.g. at a temperature close to its melting point or softening point) and non-ductile once manufacturing is completed as the temperature has dropped. Such materials may include, but not be limited to, a silicate glass, a glass, a polymer, etc.

Alternatively, the openings may be simply stamped etc., or the arrayed grid-foil may be formed by alternate techniques including, but not limited to, plating upon a template (e.g., a Lithographie, Galvanoformung, Abformung (Lithography, Electroplating, and Molding) LIGA process). Accordingly, the electrodes may be formed from a metal, an alloy, a combination of metals, a polymer etc. Within other embodiments of the invention the electrodes may be formed from one or more ceramic materials, e.g., aluminium oxide (alumina), aluminium nitride, silicon carbide, zirconium oxide (zirconia), silicon oxide (silica or glass), silicon nitride, silicon oxynitride, low temperature co-fired ceramics (LTCCs) etc. as employed within microelectronics packaging etc. through patterning green tape(s), firing etc. with metallization etc.

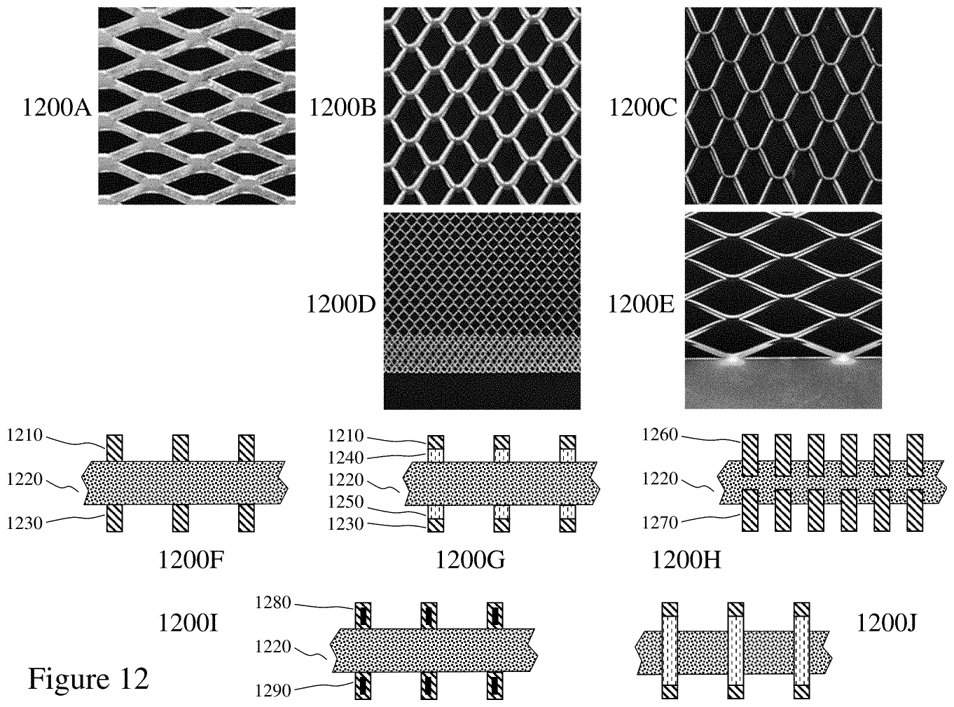

Referring to FIG. 12 there are depicted first to fifth images 1200A to 1200E of arrayed grid-foils according to embodiments of the invention, wherein:
First image 1200A depicts a flattened arrayed grid-foil;
Second image 1200B depicts an arrayed grid-foil single pulled post expanding;
Third image 1200C depicts an arrayed grid-foil double pulled post expanding;
Fourth image 1200D depicts an arrayed grid-foil with a selvage edge;
Fifth image 1200E depicts an arrayed grid-foil with solid unexpanded metal portion wherein the arrayed grid-foil with solid portions offers ability to employ the solid portions as hard point connections such as mechanical and/or electrical connections.

Further, sixth to ninth images 1200F to 1200I depict exemplary cross-sections of MEAs according to embodiments of the invention. Within sixth image 1200F upper electrode 1210 and lower electrode 1230 are disposed either side of PEM 1220 where the upper electrode 1210 and lower electrode 1230 are solid electrically conductive elements. Within ninth image 12001 the upper electrode 1280 and lower electrode 1290 either side of the PEM 1220 are formed from a conductive outer surrounding a core, e.g., gold coating over aluminum, a conductive coating over ceramic, a conductive coating over a polymeric material.

In seventh image 1200G upper electrode 1210 is disposed upon a first carrier 1240 whilst lower electrode 1230 is disposed upon a second carrier 1250 with the PEM 1220 disposed between the first carrier 1240 and second carrier 1250 which may for example be a metal, an alloy, a ceramic or a polymer. Within eighth image 1200H the upper electrode 1260 and lower electrode 1270 penetrate into the PEM 1220. The other configurations depicted within sixth, seventh and ninth images 1200F, 1200G and 1200I may similarly penetrate into the PEM 1220 such that there is no additional bonding agent between the upper and lower electrodes (electrode assemblies) and the PEM. Optionally, mechanical pressure through the design and attachment of the anode/cathode electrodes with their respective chambers etc. may provide the requisite mechanical/electrical configuration without requiring the PEM 1220 be attached through a bonding agent (e.g., adhesive, resin, epoxy etc.). Optionally, within other embodiments of the invention the PEM may be formed through a process such as dipping upon an assembly comprising the upper electrode, lower electrode and a former such as depicted in tenth image 1200J wherein the PEM is only within the openings.

It would be evident that within embodiments of the invention the configuration of the top/upper/anode electrode may be the same as that of the bottom/lower/cathode electrode.

It would be evident that within embodiments of the invention the configuration of the top/upper/anode electrode may be different from that of the bottom/lower/cathode electrode.

It would be evident that within embodiments of the invention the material(s) of the top/upper/anode electrode may be the same as that of the bottom/lower/cathode electrode.

It would be evident that within embodiments of the invention the material(s) of the top/upper/anode electrode may be different from that of the bottom/lower/cathode electrode.

It would be evident that within embodiments of the invention where an electrically conductive coating is formed upon an underlying carrier that the electrically conductive coating may be applied, for example, by sputtering, evaporation, deposition and electroplating.

It would be evident that within the embodiments of the invention described above the photosynthesis is performed by an organic material including those listed above and further comprising a photosynthetic microorganisms such as Chlamydomonas reinhardtii, a cyanobacteria, a thylakoid membrane of a plant such as spinach, moss plant leaves etc., an electrogenic bacteria such as green sulphur bacteria diatoms for example, and the reaction centers of chlorophyll molecules.

It would be evident that within the embodiments of the invention described above that the catholyte solution may comprise a highly oxidative species such as one or more of potassium ferricyanide; thionines; viologens; phenoxazines; quinones; ferrocene derivatives; ferric chelate complexes; phenothiazines; methylene blue, oxygen, and air.

It would be evident that within the embodiments of the invention described above that the anolyte solution comprises an organism that performs photosynthesis.

It would be evident that within the embodiments of the invention described above that anolyte solution may further comprise one or more of a growth medium, a mediator and a sugar.

It would be evident that within the embodiments of the invention described above that the PEM may be processed and/or treated to increase its ionic conductivity.

It would be evident that within the embodiments of the invention described above that the photosynthetic organism within the anolyte solution may be bonded to the anode electrode.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of fabricating a power cell comprising:
providing an upper electrode formed of a first material with arrayed openings of first dimensions therein;
providing a lower electrode formed from a second material with arrayed openings of second dimensions therein;
providing a proton exchange membrane (PEM) between the upper electrode and the lower electrode;
providing a first chamber filled with an anolyte comprising a photosynthetic organic material that performs photosynthesis disposed such that the upper electrode is in contact with the anolyte solution;
providing a second chamber filled with a catholyte disposed such that the lower electrode is in contact with the catholyte solution; and
an optically transparent window allowing light to enter the power cell and enable a photosynthetic reaction in the photosynthetic organic material.

2. The method according to claim 1, wherein
the upper electrode and the lower electrode are attached to the PEM by at least one:
one or more third materials;
mechanical pressure from assembling them with the first chamber and the second chamber; and
mechanical contact of them penetrating into the PEM.

3. The method according to claim 1, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between either electrode and the PEM.
the upper electrode and lower electrode are disposed in contact with the PEM such there is no gap between the upper electrode and the PEM and no gap between the lower electrode and the PEM;
the first material is electrically conductive; and
the second material is electrically conductive.

4. The method according to claim 1, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between the upper electrode and the PEM and no gap between the lower electrode and the PEM the first material is electrically conductive;
at least one of the first material or second material is non-conductive.

5. The method according to claim 1, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between the upper electrode and the PEM and no gap between the lower electrode and the PEM the first material is electrically conductive;
the first material is selected from the group comprising a metal, an alloy, a ceramic, a polymer and a resin;
the second material is selected from the group comprising a metal, an alloy, a ceramic, a polymer and a resin.

6. The method according to claim 1, wherein
the first electrode is formed upon a first surface of a carrier comprising an array of holes;
the second electrode is formed upon a second surface of the carrier opposite the first surface;
the array of holes within the carrier at the first surface of the carrier provide the arrayed openings of first dimensions;
the array of holes within the carrier at the second surface of the carrier provide the arrayed openings of second dimensions;
the carrier is electrically non-conductive such that the upper electrode and lower electrode are electrically isolated from each other; and
the PEM is disposed within a predetermined subset of the array of holes.

7. The method according to claim 1, wherein
the first material is ductile when the arrayed openings of first dimensions are formed and is selected from the group comprising a metal, an alloy, and a polymer;
the second material is ductile when the arrayed openings of second dimensions are formed and is selected from the group comprising a metal, an alloy, and a polymer.

8. The method according to claim 1, wherein the PEM is selected from the group comprising a sulfonated tetrafluroethylene based fluoropolymer-copolymer, a sulfonated αββ-trifluorostyrene-co-substituted-αββ-trifluorostyrene, a sulfonated styrene-(ethylene-butylene)-styrene triblock copolymer, and a sulfonated styrene-(ethylene-butylene)-styrene triblock copolymer.

9. The method according to claim 1, wherein
the photosynthetic organic material is selected from the group comprising photosynthetic algae, a photosynthetic bacteria, a diatom, a thylakoid membrane of a plant, a photosynthetic plant tissue, chlorophyll, a chloroplast, and an electrogenic bacteria.

10. The method according to claim 1, wherein
the organic material is micro-organisms consisting of at least one of whole cells or separated pigments; and
the anolyte is a solution further comprising at least one of a growth medium and a mediator.

11. The method according to claim 1, wherein
the catholyte is a solution containing an electrochemically active compound capable of absorbing electrons.

12. The method according to claim 11, wherein
the catholyte comprises an oxidative species selected from the group comprising potassium ferricyanide, a thionine, a viologen, a quinone, a phenazine, a phenoxazine, a phenothiazine, iron cyanide, a ferric chelate complex, a ferrocene derivative, dichlorophenolindophenol, diamino durene, oxygen, and air.

13. The method according to claim 1, wherein
the power cell generates an electrical output under both optical illumination and in the dark.

14. A power supply comprising:
a plurality of power cells, each power cell comprising:
an upper electrode formed of a first material with arrayed openings of first dimensions therein in contact with an anolyte solution comprising a photosynthetic organic material that performs photosynthesis;
providing a lower electrode formed from a second material with arrayed openings of second dimensions therein in contact with a catholyte solution;
providing a proton exchange membrane (PEM) between the upper electrode and the lower electrode; and
an optically transparent window allowing light to enter the power cell and enable a photosynthetic reaction in the photosynthetic organic material.

15. The power supply according to claim 14, wherein
each power cell generates an electrical output under both optical illumination and in the dark.

16. The power supply according to claim 14, wherein
the plurality of power cells are configured in a plurality of serially connected arrays each comprising one or more power cells of the plurality of power cells; and
the plurality of serially connected arrays are connected in parallel.

17. The method according to claim 14, wherein
the upper electrode and the lower electrode are attached to the PEM by at least one:
one or more third materials;
mechanical pressure from assembling them with the first chamber and the second chamber; and
mechanical contact of them penetrating into the PEM.

18. The method according to claim 14, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between either electrode and the PEM.
the upper electrode and lower electrode are disposed in contact with the PEM such there is no gap between the upper electrode and the PEM and no gap between the lower electrode and the PEM;
the first material is electrically conductive; and
the second material is electrically conductive.

19. The method according to claim 14, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between the upper electrode and the PEM and no gap between the lower electrode and the PEM the first material is electrically conductive;
the first material is electrically conductive; and
the second material is electrically non-conductive.

20. The method according to claim 14, wherein
the upper electrode is formed by process comprising:
mechanically forming an arrayed grid-foil of the first material from a sheet of the first material; and
coating the arrayed grid-foil of the first material with a fourth material which is electrically conductive such that the fourth material covers one or more predetermined surfaces of the arrayed grid-foil;
the lower electrode is formed by process comprising:
mechanically forming an arrayed grid-foil of the second material from a sheet of the second material; and
coating arrayed grid-foil of the second material with a fifth material which is electrically conductive such that the fifth material covers one or more predetermined surfaces of the arrayed grid-foil;
the upper electrode and lower electrode are disposed in contact with the PEM such there is no gap between the upper electrode and the PEM and no gap between the lower electrode and the PEM the first material is electrically conductive;
the first material is selected from the group comprising a metal, an alloy, a ceramic, a polymer and a resin;
the second material is selected from the group comprising a metal, an alloy, a ceramic, a polymer and a resin.

21. The method according to claim 14, wherein
the first electrode is formed upon a first surface of a carrier comprising an array of holes;
the second electrode is formed upon a second surface of the carrier opposite the first surface;
the array of holes within the carrier at the first surface of the carrier provide the arrayed openings of first dimensions;
the array of holes within the carrier at the second surface of the carrier provide the arrayed openings of second dimensions;
the carrier is electrically non-conductive such that the upper electrode and lower electrode are electrically isolated from each other; and
the PEM is disposed within a predetermined subset of the array of holes.
